(19) United States
(12) Patent Application Publication
(10) Pub. No.: US 2010/0272987 A1
(43) Pub. Date: Oct. 28, 2010

(54) ANTI-STATIC MULTI-FUNCTIONAL LAYER AND METHOD FOR USE OF THE SAME

(75) Inventors: Oliver Marte, Wattwil (CH); Martin Meyer, Thalwil (CH)

Correspondence Address: BUCHANAN, INGERSOLL & ROONEY PC, POST OFFICE BOX 1404, ALEXANDRIA, VA, 22313-1404, US

(73) Assignee: TEX-A-TEC AG, Wattwil (CH)

(21) Appl. No.: 12/528,298

(22) PCT Filed: Feb. 21, 2008
(86) PCT No.: PCT/CH08/00076

§ 371 Date: Aug. 21, 2009

(30) Foreign Application Priority Data
Feb. 23, 2007 (CH) 312/07
May 3, 2007 (CH) 723/07

(51) Int. Cl. B32B 5/16; B05D 3/12; D06M 15/564

(52) U.S. Cl. 428/328; 427/358; 252/8.61

(57) ABSTRACT

An anti-static multi-functional layer is disclosed for finishing and coating substrates and for introducing the polymer/particle composites contained in the multi-functional layer into substrates. The layer can include a polymer matrix containing at least one polymer compound and at least one non-metallic particle type and/or a metallically conductive particle type in combination with a metallic electrolyte. The particle combination can be encapsulated by a coating matrix, thus forming a multi-functional layer. A virtually continual discharge of the static charge that occurs can be guaranteed by the electrochemical reaction taking place in the layer and produces a charge neutralisation. Methods are disclosed in which the anti-static multi-functional layer is used, for example to finish textiles, to coat plastic film and coverings and to introduce the polymer/particle composites contained in the multi-functional layer into a plastic.

The invention relates to an anti-static multi-functional layer for finishing and coating substrates as well as for introducing the particle composites contained in the multi-functional layer into substrates according to claim 1, as well as the method for this purpose using the anti-static multi-functional layer according to claims 16 to 18.

The electrostatic charging of plastics and textile fiber materials, in particular synthetic fibers, is a generally known problem (Degussa-Hüls, Schriftenreihe Pigmente [Series Pigments], No. 62, pp. 6-18).

This problem is significantly amplified by the application of preparations that have a hydrophobic action, especially by fluorine carbon resin coatings and finishes. An essential factor is also the relative atmospheric humidity, since in the case of reduced atmospheric humidity, the dielectricity constant (permittivity number) decreases and thus the charge forces that occur are increased. The values that occur up until the discharge of the electric voltages can reach several thousand volts, which can lead to considerable damage, for example to electronic devices, in addition to the very unpleasant sensation that occurs when touching charged layers. The processing of plastic films and hydrophobically finished textiles represents a special problem, since the latter pick up dust particles because of their static charge and impart an unsightly appearance to the surfaces that tends to hurt sales. The above-described problem recently became even more serious with the development of superhydrophobic, lotus-structured surfaces and tightened regulations relative to the anti-static effect of protective suits, which are worn in, e.g., clean rooms (in electronics, hospitals, the military, etc.) (G. Lüttgens, Statische Elektrizität [Static Electricity] expert verlag (2005), pp. 109-139).

The causes of the static charging of textiles are triboelectric effects. The latter already occur when touching different materials and to a greater extent when materials and surfaces of varying composition undergo friction, whereby the separation of the two materials is of decisive significance. If two materials that carry different potential charges or have different electron release energies, such as for example, silk and polyethylene, are rubbed together, electrons from the polyethylene (material with the smaller electron release energy, also called the donor) transfer to the silk (material with the greater electron release energy, also called the acceptor). The tribological series is a listing of materials of strongly positive to strongly negative nature that characterize the electron transport (P. A. Tipler, G. Mosca, Physik [Physics] (2004), Spektrum Akademischer Verlag, pp. 642-643). In the second phase, the charge separation, the two materials are separated from one another, by which a reduction in capacity results because of the increase in distance. This results in an increase in the potential by several orders of magnitude. If the voltage before the separation of the materials into the electric double layer was still in the millivolt range, voltages in the kilovolt range occur after the separation. In the static charging, the overall charge of the two materials stays the same. Coehn's Rule, which states that, when two bodies are separated, the one with the higher dielectric constant (permittivity number) has a positive charge and the other has a negative charge, provides a quantitative relationship for describing most charging processes. Thus, metals and water-moistened materials are always charged positively compared to electronically non-conductive layers.

Of course, analogously to the development of the electrostatic charging, especially in textiles, an attempt was made to prevent the charging by the production of fiber mixtures with different dielectric constants. This method was ineffective, on the one hand, by the large number of materials with their varying dielectric constants coming into contact with one another (friction) in daily use, and, on the other hand, under the conditions of fashion and/or clothing physiology that are linked to the various textiles.

Another possibility that is used industrially is the simultaneous use of metal threads or metallized synthetic-fiber materials.

The agents now used in most cases for this purpose are anti-static preparations both on plastics and textile surfaces, such as, e.g., anionic and cationic softeners as well as hydrophilic polyethylene oxide derivatives. Their principle of operation is based in particular on the increase of the surface conductivity and the increase of the dielectric constants of the medium that is found between two bodies (H. Rath, Lehrbuch der Textilchemie [Textile Chemistry Textbook], Springer Verlag Berlin (1972), pp. 341-343).

In the unprepared surfaces, air represents the dielectric, and in the case of a prepared surface, it is a combination of air and preparation agents. In addition to the ionogenic groups, molecule groupings are in the preparation agents that are capable of creating dipoles and thus counteract the static charging. The surface-active substances that are used therefore have a greater anti-static action, the more pronounced their polar nature and the longer the fatty chain of this product.

The newest anti-static coatings contain various heavy metal oxides, whose antistatic principle is based essentially on the increase in the permittivity number (EP 1 245 968 A2, Laminate Comprising a Needle-Like Anti-Reflecting Film Comprising the Same; WO 2006/068466 A1, Curable Composition Containing Conductive Particles, Cured Product of the Curable Composition, and Laminate).

Common to all known proposed solutions is external charge removal and, in the case of anti-static preparations, the only very limited washability and adherence of such finishes, or preparations and their limited possible applications. According to existing finish principles, anti-static and superhydrophobic effects within a coating or finish are therefore excluded. Thus, the coating and finish experts are forced to agree to unattractive compromises relative to the required effects of a finish or coating, which in many cases have negative economic results (customer complaints, etc.)

The use of metallized threads, e.g., in the production of fabrics, is very costly and limits the flexibility of the textile finisher, since such a solution relates to the entire infrastructure chain of the textile production.

The object of the invention is to produce an anti-static multi-functional layer, which allows the achievement of a high anti-static effect without external charge dissipation and without in the process disrupting the effects of additionally applied functional layers (e.g., superhydrophobic effects).

At the same time for an anti-static effect, it is another object of this invention to achieve a bactericidal and/or fungicidal function in the finishing of textile patterns, which protects the latter overall against bacterial and fungicidal infestation.

Another object of the invention is to eliminate influences of residual chemicals that are possibly present and that disrupt the functional effects by the multi-functional layer that is applied to the substrate.

Another object of the invention is ultimately to indicate methods that have been applied to the most varied substrates with use of the anti-static multi-functional layer.

The solution of the set object essentially exists in the design of a multi-functional layer of the first type, which ensures an almost continuous discharge of the static charges that occur by the electrochemical reactions that run in this layer, which lead to a “charge neutralization.”

The term substrate defines fibers and fiber materials of any type, textile patterns, plastic films and plastic coverings.

A second proposed solution exists in the use of new polymer formulations that previously were not used in the textile industry. The latter serve, on the one hand, in adherence and/or washability of the multi-functional layer and, on the other hand, as a carrier matrix for the nanoparticles that have the various anti-static, bactericidal, fungicidal, coloring, adhesive, etc., functions. The nanoparticles that are contained in this multi-functional layer of the first type have bactericidal and fungicidal properties and in addition have the mode of operation of chemical half-cells, which use the neutralization of electrostatic charges in combination with the chemical carrier matrix, which also can have the properties of an electrolyte.

An essential feature of the invention is the use of nanoparticles, consisting of noble and base metals. The latter can be present as metal particles but also as metal precipitate on, for example, ceramic nanoparticles and can design thus-mentioned half-cells with the metal ions that are adsorbed on the metal surface (C. H. Hamann, W. Vielstich, Elektrochemie [Electrochemistry] Wiley—VCH Weinheim (1998), pp. 65-68, pp. 107-116).

Another feature is the use of non-metal material particles in combination with a metal salt. In the case of a negative static surface charge that occurs, an electric breakdown results on the nanoparticles with the highest electron affinity (nanoparticles of the noble metal). This results in the deposition of noble metal ions, adsorbed on the metal surface, with which the pre-existing charge is neutralized. During the occurrence of positive, static charges, the charge equalization takes place with the base metal, as a result of which electrons are released and the base metal goes “into solution.”

As an example, the negative charging of the multi-functional layer surface can be mentioned, whereby the multi-functional layer contains silver nanoparticles with silver ions adsorbed on their surface. The charge equalization takes place between the negatively charged multi-functional layer surface and the silver ions according to the reaction equation (I). The charge equalization results in the deposition of the silver ion as a metallic silver on the silver particle surface.

Ag⁺+e⁻ [symbol] Ag (I)

A positive charging of the multi-functional layer surface with the aluminum particles that are present in the multi-functional layer and the adsorbed Al ions results in the breakdown of the metal aluminum according to the reaction equation (II).

Al [symbol] Al³⁺+3e⁻ (II)

The metallic or metal-bearing nanoparticles are stored in a polymer matrix that can be dominated both cationically or anionically as well as non-ionogenically and can contain additional free amino and/or OH groups. The polymers that are used are electrically conductive and/or non-conductive polymers which, on the one hand, can be chemically cross-linked or are water-insoluble and, on the other hand, have water-absorbing properties, so that electrochemical redox reactions are possible.

Another feature of the invention is the use of nano-metal particles, which form both galvanic half-cells and act as bactericidal and/or fungicidal substances, such as, e.g., silver and copper, tin and antimony.

According to the invention, non-metallic, particulate materials with particles sizes of 10 nm-10 μm in combination with metal ions absorbed on the material surface can also be used.

This is primarily the case if, based on materials that come into contact, the multi-functional layer is negatively charged as expected. In this case, the metal deposition of the metal ion, for example carbon/iron ion, takes place on the carbon surface according to the reaction equation (III).

Fe²⁺+2e⁻ [symbol] Fe (III)

Another feature according to the invention relates to the use of organic polyelectrolytes for the production of the polymer matrix, which have a high affinity to the fiber material owing to their limited water solubility and thus can be attached. The residual chemicals that adhere to the fiber material are adsorbed by the polymer matrix and thus are immobilized. A high adhesion of the polymer matrix to the fiber and/or plastic material results through this immobilization of the disruptive residual chemicals. The partial cross-linking of the polymer matrix with, for example, isocyanates or amino alkylation products results in complete water insolubility of the polymer layer. This simultaneously offers the possibility based on the still free reaction groups for a multi-functional layer of the second type that is applied to the polymer layer, e.g., to be affixed chemically and thus to be adherent and/or washable in order to achieve superhydrophobia.

Another feature of the coating method for creating the multi-functional layer of the first type is the use of a polymer/particle composite for achieving the anti-static function. The latter can contain other ingredients in addition to the organic polymers and nanoparticles. As ingredients, e.g., cross-linking components or cross-linking catalysts are suitable—through the use of a composite formulation—to make available to the textile finisher or plastic coater a simple application technique to which he is accustomed.

The coating method according to the invention offers the ability to produce highly adherent and/or washable bactericidal, fungicidal and antistatic effects in a multi-functional layer of the first type. Moreover, it offers the ability to attach—in a chemically highly washable manner—another applied multi-functional layer of the second type, which has completely different properties.

Embodiments of the Anti-Static Multi-Functional Layer:

A first essential component of the anti-static multifunctional layer of the first type is the polymer matrix, which contains at least one polymer compound, preferably an anionic or cationic polyelectrolyte, which can be applied in a particulate (particles of 10 nm-10 μm) or film-forming manner on the substrate.

As possible polymer compounds, cellulose and starch derivatives, polyacrylates, polyamides, but also polyurethane and polyester compounds are suggested, which for their part are mixed with other polymers or block polymers of a different type. The polymer matrix can also contain UV—and/or electron-beam-hardening polymers. Another possibility is the use of electrically conductive polymers, such as, e.g., polyanilines, polypyrroles and polythiophenes as well as UV-hardening polymers, such as Desmolux U 100 and Desmolux VP LS 2266 of the Bayer Company. Preferably used polyelectrolytes are cationically dominated compounds with a balanced hydrophilic-lipophilic nature. The HLB (hydrophilic lipophilic balance) value of these compounds is in the range of 5-18, preferably 8-15.

Micro- and nanoparticle combinations of metals with different standard redox potentials, which consist both of pure metals and can be affixed to microscale and nanoscale carrier materials, are a second component of the multi-functional layer of the first type. At least one particle type has been used that is metallic when the charging of the layer is expected to be positive and can consist of a non-metallic conductor (in combination with a metal salt) and/or a metallic conductor when the charging is expected to be negative. Non-metallic particles that are preferably used are carbon forms of different polarity, such as, e.g., nanotubes and spherical soot pigments. Preferably, however, at least two metallic particle types, which are distinguished in their standard redox potential, are used. Examples of such metal combinations are silver-zinc (Ag—Zn), silver-aluminum (Ag—Al), copper-iron (Cu—Fe), and cobalt-manganese (Co—Mn). As microscale and/or nanoscale carrier materials, particulate organic and inorganic materials are used, such as, e.g., cellulose, glucan, chitosan, polyethylene, polypropylene, polyoxymethylene, carbon, metal and non-metal oxides; ceramic materials are preferably used, such as, e.g., silicon and titanium dioxide, aluminum oxide and zirconium oxide. The microparticles and/or nanoparticles that consist of metals or of metal-charged carrier materials can also have a coating containing metal salt, whereby the metal ion is of the same type as the metal that is present in the particle in elementary form. The microparticles and nanoparticles that are used have a diameter of 0.1-10 μm, preferably 300-600 nm.

The coating matrix that sheathes the particles preferably consists of anionically or cationically derivatized polymers, such as, e.g., cellulose derivatives, polyester, polyurethane, polyvinyl acetate or polyvinyl acrylate, or mixtures of the above-mentioned polymers, but preferably of the same polymer that forms the host matrix.

Organic and/or inorganic bactericidal and fungicidal components or compounds are a third optionally used component. As organic compounds, compounds that support quat groups with a carbon chain of C₃-C₂₀, preferably C₁₂-C₁₈, are preferably used. Other compounds that are used in this connection are compounds that cleave aldehyde or hydrogen peroxide.

Preferably used inorganic bactericidal and fungicidal agents, or components are microscale and nanoscale silver and copper particles, which thus take over a dual function, since they are also able to form galvanic half-cells and as such have an anti-static action according to the invention.

This dual function was found surprisingly and unexpectedly and offers enormous functional and economic advantages, based on the simple multi-functional layer design, relative to conventional coatings, which in each case have only one of the above-mentioned properties.

Another surprising and also unexpected manifestation of the anti-static concept according to the invention is an inhibition of corrosion, e.g., of an on-iron multi-functional layer that contains aluminum particles. The operating principle in this connection corresponds to the cathodic corrosion protection. In the case of the above-mentioned example, iron/aluminum is a potential difference of primarily about 1.3 V, which is large enough to achieve the above-mentioned corrosion inhibition (G. Korttüm, Lehrbuch der Elektrochemie [Electrochemistry Textbook], Verlag Chemie GmbH, Weinheim (1966), pp. 571-572).

Various cross-linking agent types, such as, e.g., isocyanates, aziridines and aminoalkylation products, are a fourth optionally used component in the multi-functional layer of the first type. Possible catalysts required for the respective cross-linking agent system are preferably added only to the impregnating baths instead of admixing in the polymer/particle composite.

With these components, reaction groups are simultaneously made available for a later chemical cross-linking of components of a multi-functional layer of the second type, which are responsible for the adherence and/or the fastness of washing of the multi-functional layer of the second type, which, for example, is a finishing layer on a textile pattern. Of course, the cross-linking agent system can also consist of more than only one cross-linking agent component.

### EXAMPLE 1

### Anti-Static and Fungicidal Multi-Functional Layer on Industrial Fabrics (Awning Material) with Additional Hydrophobization

10 g of nanoscale copper particles with a mean grain size of 0.8 μm is dispersed in a methocel solution (hydroxypropyl methyl cellulose) that consists of 50% water, 50% isopropanol, 6 g/l of the trimer of 3-isocyanatomethyl-3,5,5-trimethylcyclohexyl-isocyanate (IPDI trimer), 0.1 g/l of dibutyl tin laurate, and 2 g/l of a nitrilotriacetic acid-copper complex.

The thus created polymer/particle composite is applied on an industrial polyester fabric with a square meter weight of 250 g/m². The liquor layer is 70% relative to the fabric dry weight. Then, the drying and the chemical fixing are carried out at 130° C. for 2 minutes.

In a second operating step, an impregnating liquor is applied with 30 g/l of a fluorine carbon resin (Softgard M3 of the Soft Chemicals Company, Italy) and 5 g/l of a polyisocyanate (Softgard plus the Soft Chemicals Company, Italy) on the fabric that is finished with the multi-functional layer. The chemical fixing is carried out at 150° C. for three minutes.

The anti-static fungicidal and hydrophobic finish that is produced according to this method shows a surprising adherence and washability of the finish. Up to 20 washing cycles with the finished awning material can be performed at 40° C., with no noticeable loss of effect.

### EXAMPLE 2

### Anti-Static, Fungicidal and Hydrophilizing Film Coating

50 g/l of nanoscale copper particles with a mean grain size of 0.8 μm is dispersed in a polymer solution of 40% water and 50% isopropanol, 120 g/l of Desmophen 1100 (Bayer Company) as well as 5 g/l of the trimer 3-isocyanatomethyl-3,5,5-trimethylcyclohexylisocyanate (IPDI trimer), 0.1 g/l of dibutyl tin laurate, and 5 g/l of a nitrilotriacetic acid-copper complex. Analogously, a polymer/particle composite that consists of aluminum particles is produced with a mean grain size of 0.8 μm and a nitrilotriacetic acid-aluminum complex.

The formulation that is produced for coating the HD-polyethylene film contains 100 g/l each of the copper and aluminum particle composite, which is dispersed in an aqueous/alcoholic 50% solution of Desmophen 1100. Additional ingredients are attached to the polymer solution, such as 10 g/l of IPDI trimer, and 0.1 g/l of dibutyl tin laurate. The drying and chemical fixing of the layer is carried out at 90° C. for 1 minute.

The thus coated polyethylene film shows surprising anti-static and fungicidal effects (itself after extended storage in water), as well as a complete wettability with water.

### EXAMPLE 3

### Anti-Static Polyvinyl Chloride Film

Production of the polymer/particle composite: 50 g of aluminum particles with a mean grain size of 0.6 μm and 2.5 g of an aluminum-nitrilotriacetic acid complex as well as 5 g of Dapral GE 202 (Akzo Chemie), 15 g of toluoylene diisocyanate, and 927.5 g of Desmophen 800-85 (Bayer) are homogenized in the modeling clay aggregate at 60-70° C.

Production of the film: 100 g of the described polymer/particle composite is mixed with 100 g of dioctyl phthalate and homogenized. Then, 800 g of a polyvinyl chloride granulate is added and intensively mixed in a homogenizer. The particle-granulate mixture is extruded in the extruder at 180° C. to form a film with a thickness of 0.2 mm.

The polyvinyl chloride film that is produced in this way shows the desired anti-static action in mechanical strength values according to expectations in comparison to conventionally produced polyvinyl chloride films, but without the addition of the polymer/particle composite.

### EXAMPLE 4

### Anti-Static, Bactericidal and Hydrophobic Multi-Functional Layer on Outdoor Fabric

8 g of aluminum particles with a mean grain size of 4 μm is dispersed in 100 ml of an aqueous/alcoholic solution (20%/80%) of methocel (hydroxypropyl methyl cellulose) and an amino-functional polyester resin (Desmophen NH 1521). The methocel portion is 0.5% by weight, and the portion of the polyester resin is 2.5% by weight, both portions relative to the solvent mass.

As additional components, 4 g of Desmodur BL 1100 (Bayer MaterialScience, Germany) and 0.1 g of dibutyl tin laurate are added. Then, a wet milling process is carried out to reduce the mean grain size of 4 μM to 0.8 μm. During this treatment, small amounts of aluminum hydroxide are formed, which are primarily adsorbed on the metal surface. In this way, the requirements for forming a galvanic half-cell are met, without explicit addition of an electrolyte (e.g., Al³⁺salt), by which this example is distinguished from Example 1. In this example, this is a system-intrinsic formation of the half-cell.

The thus produced particle composite is dispersed in a solution that contains binding agent (Dorafresh BL 6 g/l) and silver salt (Dorafresh AG 2 g/l).

The finished polymer/particle composite is applied to a polyester fabric with a square meter weight of 150 g. The pick-up is 45% relative to the fabric dry weight. In connection to the application of the particle/polymer composite, the drying of the fabric is carried out at 120° C.

In a second operating step, an impregnating liquor with 30 g/l of a fluorine carbon resin (Softgard M3 of the Soft Chemicals Company, Italy) and 5 g/l of a polyisocyanate (Softgard plus the Soft Chemicals Company, Italy) is applied to the fabric that is finished with the multi-functional layer. The chemical fixing is carried out at 160° C. for two minutes.

The anti-static, bactericidal and hydrophobic finishing that is produced according to this method has a high washability in addition to the high anti-static, hydrophobic, and bactericidal effects. After 25 washing cycles at 40° C., no loss of effect can be detected.

1. Anti-static multi-functional layer comprising:
a polymer matrix, which contains at least one polymer compound, having at least one non-metallic and/or metal-conductive particle type in a particle combination with a metal electrolyte; and
a coating matrix formed as a sheath for the particle combination such that a multi-functional layer is formed, for substantially continuous discharge of static charge that occurs by electrochemical reaction running in the layer to provide charge neutralization.

2. Multi-functional layer according to claim 1, wherein the particle combination has metals with different standard redox potentials, whereby the metals form galvanic half-cells with a metal ions that are absorbed on a metal surface.

3. Multi-functional layer according to claim 1, wherein the particle combination consists of microparticles and/or nanoparticles with diameters of 0.1-10 μm.

4. Multi-functional layer according to claim 1, wherein the polymer matrix contains cellulose and starch derivatives, polyacrylates, polyamides, polyurethane and polyester compounds and mixtures thereof as polymer compounds.

5. Multi-functional layer according to claim 1, wherein the polymer matrix contains electrically-conductive polymers

6. Multi-functional layer according to claim 1, wherein the polymer matrix contains UV—and/or electron-beam-hardening polymers.

7. Multi-functional layer according to claim 1, wherein the polymer matrix is affixed to a substrate physically and/or chemically with cross-linking reagents or by UV hardening.

8. Multi-functional layer according to claim 1, wherein the polymer matrix consists of film-forming polymer compounds with particle sizes of 10 nm to 10 μm.

9. Multi-functional layer according to claim 1, wherein the polymer matrix contains an anionic or cationic polyelectrolyte.

10. Multi-functional layer according to claim 1, wherein the coating matrix consists of anionically or cationically derivatized polymers

11. Multi-functional layer according to claim 1, comprising:
bactericidal and/or fungicidal components.

12. Multi-functional layer according to claim 11, wherein the bactericidal and/or fungicidal components are organic compounds

13. Multi-functional layer according to claim 11, wherein the bactericidal and fungicidal components are inorganic

14. Multi-functional layer according to claim 1, comprising:
at least one cross-linking component.

15. Multi-functional layer according to claim 14, wherein the cross-linking components are at least one of isocyanates, aziridines, and amino-alkylating products.

16. Method for finishing textile patterns with an anti-static multi-functional layer including:
a polymer matrix, which contains at least one polymer compound, having at least one non-metallic and/or metal-conductive particle type in a particle combination with a metal electrolyte; and
a coating matrix formed as a sheath for the particle combination, such that a multi-functional layer is formed, for substantially continuous discharge of static charge that occurs by electrochemical reaction running in the layer to provide charge neutralization, the method comprising:
stirring the polymer matrix having the particle solution into a solution that contains a film-forming polymer or a suspension; and
applying the solution on a textile material as a finishing liquor.

17. Method for coating plastic films and coverings with an anti-static multi-functional layer including:
a polymer matrix, which contains at least one polymer compound, having at least one non-metallic and/or metal-conductive particle type in a particle combination with a metal electrolyte; and
a coating matrix formed as a sheath for the particle combination, such that a multi-functional layer is formed, for substantially continuous discharge of static charge that occurs by electrochemical reaction running in the layer to provide charge neutralization, the method comprising:
introducing the polymer matrix having the particle combination in a coating mass; and
applying the coating mass to a plastic film and covering by coating, foaming or knife-coating.

18. Method for introducing a particle composite that is contained in a multi-functional layer into a plastic with an anti-static multi-functional layer including:
a polymer matrix, which contains at least one polymer compound, having at least one non-metallic and/or metal-conductive particle type in a particle combination with a metal electrolyte; and
a coating matrix formed as a sheath for the particle combination, such that a multi-functional layer is formed, for substantially continuous discharge of static charge that occurs by electrochemical reaction running in the layer to provide charge neutralization, the method comprising:
introducing the polymer matrix having the particle combination into plastic granulate; and
extruding the polymatrix with the plastic granulate.
